(19) United States
(12) Patent Application Publication
(10) Pub. No.: US 2009/0142967 A1
(43) Pub. Date: Jun. 4, 2009

(54) Contact Member, Holding Structure of Contact Member and Electrical Connector

(76) Inventor: Yoshinori Watanabe, Tokyo (JP)

Correspondence Address: BARLEY SNYDER, LLC, 1000 WESTLAKES DRIVE, SUITE 275, BERWYN, PA, 19312, US

(21) Appl. No.: 12/324,171

(22) Filed: Nov. 26, 2008

(30) Foreign Application Priority Data
Nov. 29, 2007 (JP) 2007-309365

(51) Int. Cl. H01R 24/00; H01R 13/02

(52) U.S. Cl. 439/660; 439/889

(57) ABSTRACT

An electrical connecter capable of preventing a contact member from being lifted up without inhibiting reduction in height is provided. A contact member of an electrical connector, which is held in a housing including a press-fit hole and a support surface, and is to be connected to a mating contact member is provided. The contact member includes a flat contact portion for contact with the mating contact member, and is disposed along the support surface, a flat press-fit fixing portion, which is connected to the contact portion, and is press-fitted into the press-fit hole, a tine portion connected to the press-fit fixing portion, and a lug extending from a side surface of the press-fit fixing portion, and the lug includes a support piece and an inclined piece.

### CROSS-REFERENCE TO RELATED APPLICATIONS

This application claims the benefit of the filing date under 35 U.S.C. §119(a)-(d) of Japanese Patent Application No. 2007-309365, filed Nov. 29, 2007.

### FIELD OF THE INVENTION

The present invention relates to a contact member held in an insulated housing of an electrical connector and its holding structure, and particularly relates to a holding structure of a contact member suitable for a low profiled header, which is soldered to a printed wiring board.

### BACKGROUND

Electrical connectors (hereinafter, simply called a connector) that interconnect printed wiring boards (hereinafter, simply called wiring boards), having electronic components mounted in a parallel, are commonly known in the art, especially when used inside electronic equipment such as the personal computer. These connectors are generally mounted on each of the wiring boards, and are sometimes known as vertical headers.

Japanese Utility Model Laid-Open No. 4-99378 discloses a high-density connector, which is a compact connecter having a number of contact members. As shown in FIG. 14, the connector 200 has a plurality of terminal plate mating portions 202 formed in the rear portion of a housing 201, and after terminal units 203 mate with the terminal plate mating portions 202, each of the terminal units 203 are then welded to the housing 201, rigidly connecting the two. In the terminal unit 203, a number of contact members 205 and 206 are embedded in a terminal plate 204. The terminal plate 204 being short in dimension along a longitudinal direction with a narrow width in two rows at predetermined pitches. Contact portions 205a and 206a of the contact members 205 and 206 are disposed in a mating recess 207, along insulated walls 208 formed in the mating recess 207 of the housing 201.

In the connector 200, projections 208a are formed at upper end portions of the insulated walls 208. In plan view, the contact portions 205a and 206a are hidden by the projections 208a. Specifically, the projections 208a are provided to prevent the contact members of a mating connector (not shown) from colliding with the tip ends of the contact portions 205a and 206a when the connector 200 mates with the mating connector. When the contact members of the mating connector collide with the tip ends of the contact portions 205a and 206a, mating may become insufficient. Alternatively, the contact portions 205a and 206a and even the contact members of the mating connector may be damaged.

With the miniaturization of electrical equipment, the connector 200 is required to be of a reduced height, that is, to reduce its height in correspondence with size of electronic equipment. However, it is not advantageous to minimize the height of the connector 200, in which the projections 208a are provided at the tip ends of the insulated walls 208, because the insulated walls 208 become higher correspondingly to formation of the projections 208a.

As shown in FIG. 15, a connector 300 described in Japanese Patent Laid-Open No. 2001-102120 is not provided with the projections at the upper ends of the insulated walls, as described in the Japanese Utility Model Laid-Open No. 4-99378 connector 200, and therefore, the connector 300 can be reduced in height.

Incidentally, a contact member 303 is only restrained to a housing 301 by press-fitting its raised portion into a bottom floor 301b. Accordingly, when a force is applied to a tine portion 303b of the contact member 303 in the direction shown by an arrow, the contact member 303 rotates in the direction shown by an arrow around the press-fitted portion. Thereupon, a contact portion 303a displaces in the direction away from an insulated wall 302. Thereupon, the contact portion 303a is likely to collide with a contact portion 304a of a contact member 304 of a mating connector. Hereinafter, displacement of the contact portion 303a in the direction to be away from the insulated wall 302 will be called “lift” of the contact portion.

When the thickness of the bottom floor 301b of the housing 301 becomes thin, the contact member 303 may easily rotate when a force is applied to the tine portion 303b in the direction shown by the arrow. This is because the length of the bottom floor 301b, which restrains the contact member 303, becomes short. When the connector 300 is reduced in height, a predetermined mating length needs to be measured. Therefore, the thickness of the bottom floor 301b is made thin. Accordingly, when the connector 300 is reduced in height, the contact portion 303a is easily lifted from the insulated wall 302.

### SUMMARY

The present invention is made in view of the technical problem described above, and it is an object of the present invention to provide a contact member capable of preventing a contact portion from being lifted from an insulated wall of a housing, without inhibiting reduction in height.

It is further an object of the invention to provide a holding structure of the contact member and a connector, which prevent the contact portion from being lifted from the insulated wall by using the contact member. The contact member, of the present invention, comprising a contact member of a connector, which is held in a housing having a press-fitting hole and a support surface, and is connected to a mating contact member. The contact member further comprising a flat contact portion in order to mate with the mating contact member, and disposed along the support surface, a flat press-fit fixing portion that is connected to the contact portion and is press-fitted into the press-fit hole, a tine portion connected to the press-fit fixing portion, and a lug extending from a side surface of the press-fit fixing portion, wherein the lug includes a inclined piece projected to the support surface side from the contact portion, and the projected portion is disposed at a side opposite from the contact portion with respect to the press-fit fixing portion.

### BRIEF DESCRIPTION OF THE DRAWINGS

The invention will be explained in greater detail in the following with reference to embodiments, referring to the appended drawings, in which:

FIG. 1 is a plan view of a plug connector according to the present embodiment;

FIG. 2 is a front view of the plug connector of FIG. 1;

FIG. 3 is a perspective view of a housing constituting the plug connector of FIG. 1;

FIG. 4 is a plan view of a receptacle connector which mates with the plug connector of FIG. 1;

FIG. 5 is a front view of the receptacle connector of FIG. 4;

FIG. 6 is a perspective view of a housing constituting the receptacle connector of FIG. 4;

FIGS. 7A to 7C are views showing a contact member used in the plug connector of FIG. 1, FIG. 7A shows a front view, FIG. 7B shows a side view and FIG. 7e shows a plan view;

FIGS. 8A to 8C are views showing a conventional contact member, FIG. 8A shows a front view, FIG. 8B shows a side view, and FIG. 8e shows a plan view;

FIG. 9 is a partial sectional view showing the state in which the contact member, according to the present invention, is held in the housing of the receptacle connector;

FIG. 10 is a partial sectional view showing the state in which the conventional contact member is held in the housing of the receptacle connector;

FIG. 11 is a view showing the state of the contact members in the manufacturing process;

FIG. 12 is a view showing another example of the contact member according to the present invention;

FIGS. 13A and 138 are views showing another example of the contact member according to the present invention, FIG. 13A shows a front view, and FIG. 138 shows a side view;

FIG. 14 is a perspective view showing the connector disclosed in Japanese Utility Model Laid-Open No. 499378; and

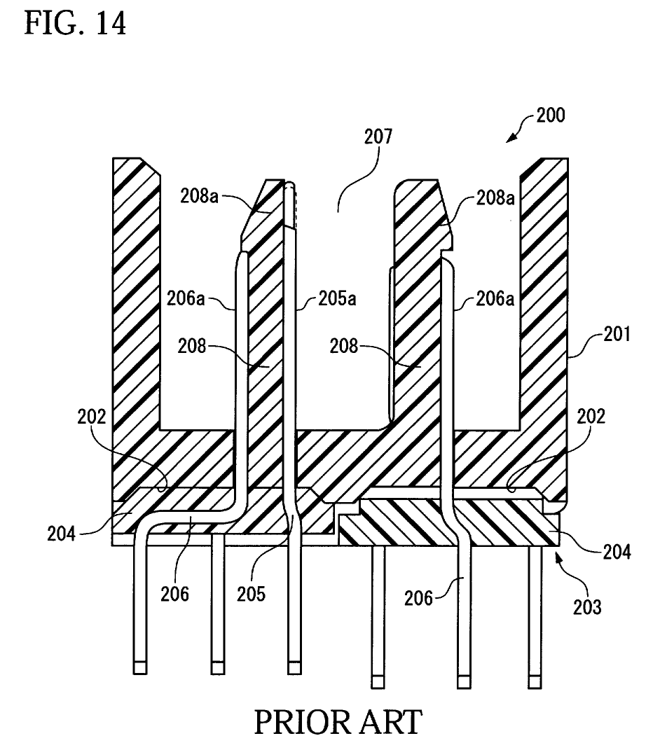

FIG. 15 is a perspective view showing the connector disclosed in Japanese Patent Laid-Open No. 2001-102120.

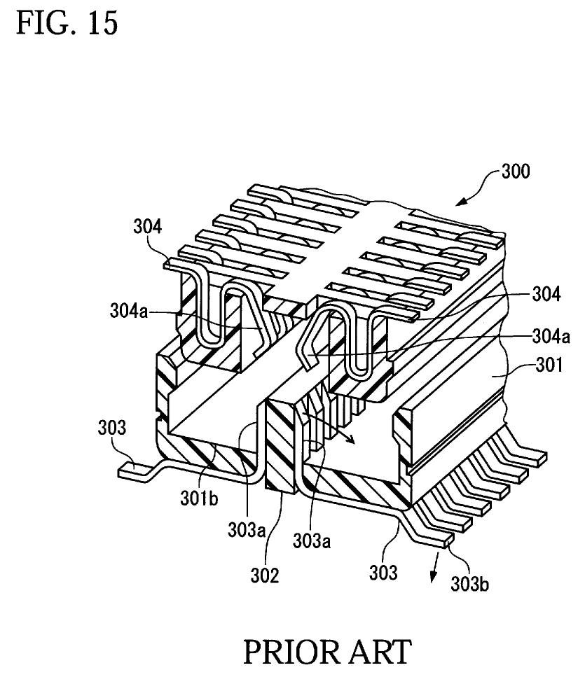

### DETAILED DESCRIPTION OF THE EMBODIMENT(S)

Hereinafter, a preferred embodiment of a connector, according to the present invention, will be described in detail with reference to the accompanying drawings. The present embodiment is an example in which the present invention is applied to a docking connector, which connects a notebook type personal computer (hereinafter, called a note PC) and a docking station, which is an extension unit, to each other.

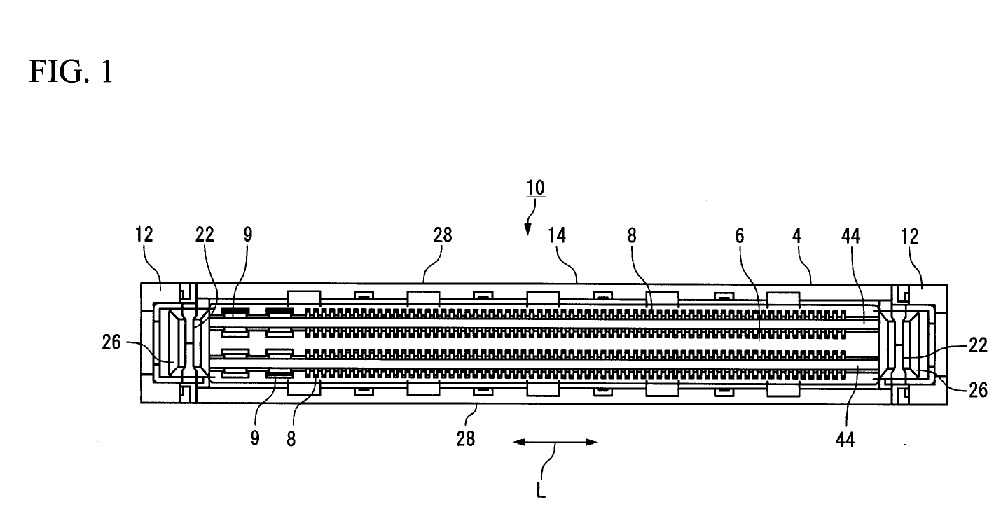

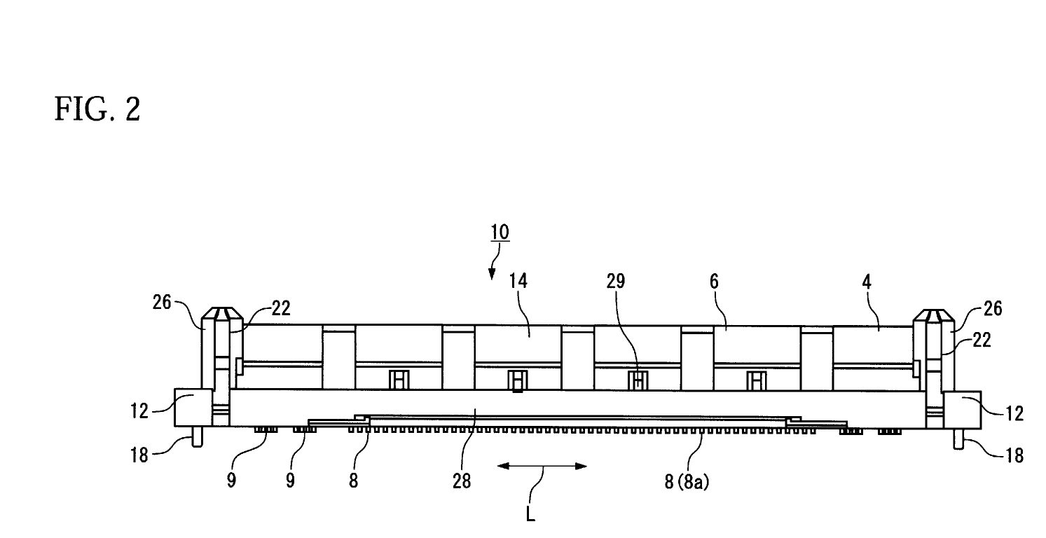

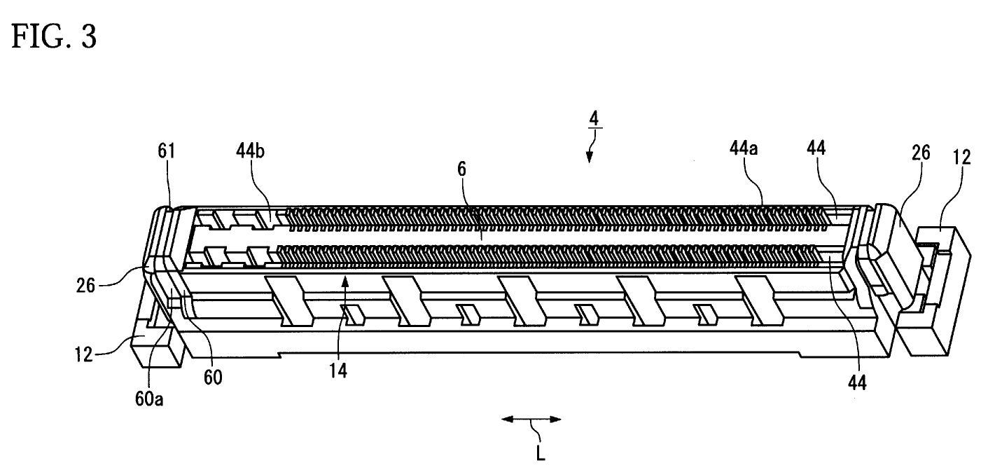

FIGS. 1 to 3 show a plug connector 10 of the present embodiment. FIG. 1 is a plan view of the plug connector 10, FIG. 2 is a front view, and FIG. 3 is a perspective view of a housing 4, constituting the plug connector 10. The plug connector 10 is placed on a top surface of the docking station.

In FIGS. 1 to 3, the plug connector 10 has an elongated insulated housing 4, and contact members 8 and 9, which are held in a mating portion 6 of the housing 4. The contact members 8 and 9 are formed in four rows along a longitudinal direction L of the housing 4.

The contact member 8 has a narrow width that is advantageous for signal transmission, while the contact member 9 has a larger width that is advantageous for power supply.

The housing 4 has a main body 14, formed in a rectangular parallelepiped shape, extending in the longitudinal direction L. The housing 4 has mounting portions 12, also formed in a rectangular parallelepiped shape, which are located at both ends of the housing 4. The main body 14 and the mounting portions 12 are integrally molded from a synthetic resin, in the preferred embodiment.

Each of the mounting portions 12 are mounted with a holding metal fitting 22. Each holding metal fitting 22 has a holding leg 18, which extends to the side of a wiring board on which the plug connector 10 is mounted. The holding leg 18 is used when the plug connector 10 is mounted on the wiring board.

The plug connector 10 further comprises guide posts 26, which are inserted into guide holes 118 of a receptacle connector 100. The guide posts 26, which will be described in greater detail below, are provided at both ends of the mating portion 6, projecting in the mating direction. The guide posts 26 serve as guide and lock functions.

The housing 4 is mounted with shield shells (hereinafter, simply called shells) 28. Each shell 28 is formed by being stamped out of one metal sheet and bent.

Additionally, the housing 4 includes mating grooves 44 in the mating portion 6 of the housing 4. The mating grooves are formed in two rows, along the longitudinal direction L, and a plurality of contact receiving grooves 44a and 44b are formed at both sides of the mating groove 44. The contact receiving grooves 44a and 44b are respectively formed in accordance with the widths of the contact members 8 and 9. The contact members 8 are disposed in the contact receiving groove 44a, and the contact members 9 are disposed in the contact receiving groove 44b.

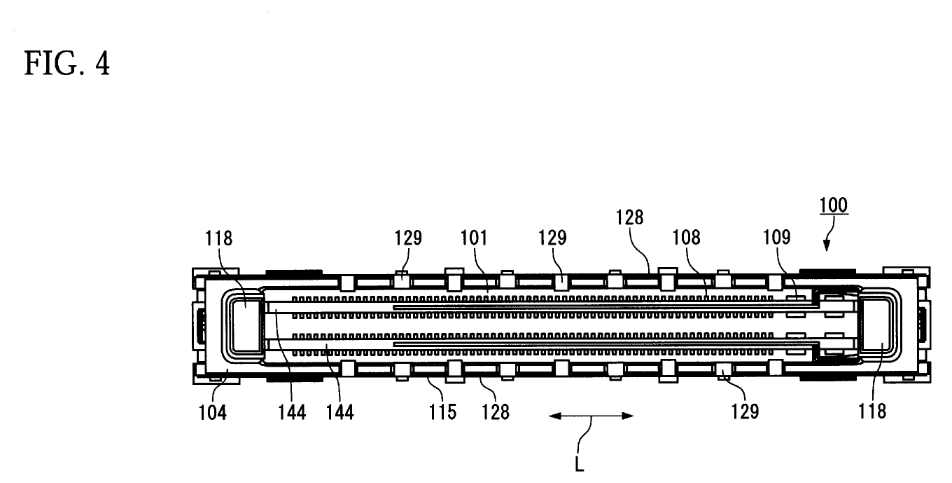

Next, the mating receptacle connector 100, which mates with the plug connector 10, will be described in greater detail with reference to FIGS. 4 to 6.

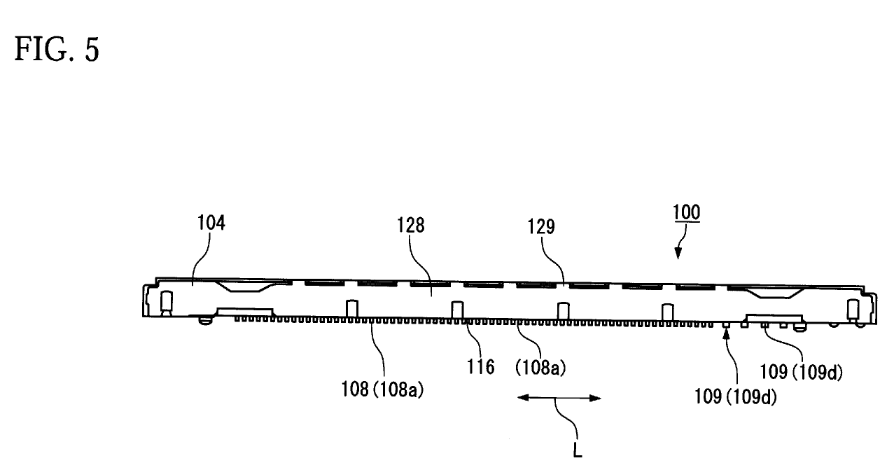

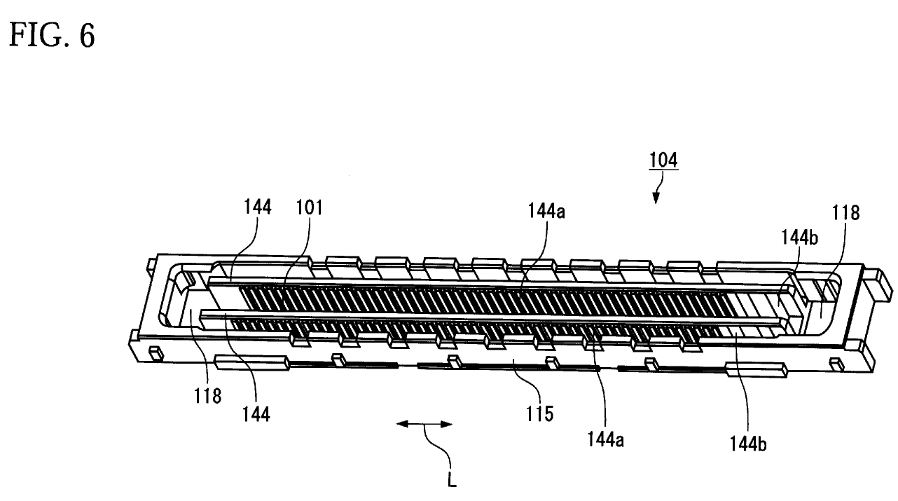

FIG. 4 is a plan view of the receptacle connector 100, FIG. 5 is a front view of it, and FIG. 6 is a perspective view of a housing 104 of the receptacle connector 100. The receptacle connector 100 is placed on the bottom surface of a note pc.

The receptacle connector 100 includes an insulated housing 104, formed in a rectangular parallelepiped shape, a shield shell (hereinafter, simply called a shell) 128 made of a metal and formed to cover a side wall 115 of the housing 104, and a plurality of contact members 108 and 109 held in the housing 104. The contact members 108 and 109 are respectively connected to the contact members 8 and 9 of the plug connector 10.

In the housing 104, a mating recess 101 extending along the longitudinal direction L is formed. In the mating recess 101, mating ribs 144 are formed in two rows, which mate with the mating grooves 44 of the plug connector 10 when connected. The mating ribs 144 are integrally constructed with the housing 104, along the longitudinal direction L. On the side surface of the mating rib 144, a plurality of contact receiving grooves 144a and 144b are formed. The contact receiving grooves 144a and 144b are respectively formed in accordance with the width of the contact members 108 and 109.

The contact members 108 are disposed in the contact receiving groove 144a, and the contact members 109 are disposed in the contact receiving groove 144b. The contact members 108 and 109 are disposed in the contact receiving grooves 144a and 144b, and are placed in rows at both sides of each of the mating ribs 144.

Guide holes 118, for receiving the guide posts 26 of the plug connector 10, are formed at both end portions in the longitudinal direction L of the housing 104.

The contact members 108 and 109 have tine portions 108a and 109c which are respectively connected to wiring boards (not shown), and the tine portions 108a and 109c are exposed from the undersurface of the housing 104.

When the plug connector 10 and the receptacle connector 100 are mated with each other, the contact members 8 and the contact members 108 are connected, and the contact members 9 and the contact members 109 are connected.

In the present embodiment the shape of the contact member 109 prevents the contact portion 109a from being lifted from the insulative wall without inhibiting reduction in height of the docking connector constituted of the plug connector 10 and the receptacle connector 100. Here, the contact member 109 is taken as an example, but it goes without saying that the present invention can be applied to the contact members 8 and 9 and 108.

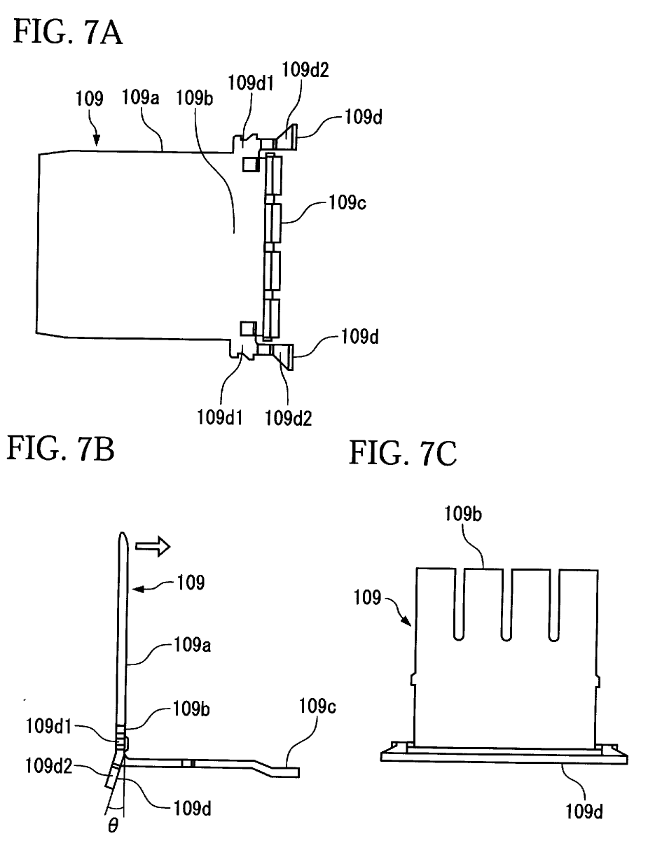

FIGS. 7A to 7C are views showing the contact member 109, FIG. 7A shows a front view, FIG. 7B shows a side view, and FIG. 7C shows a plan view.

The contact member 109 is L-shaped in the vertical section, and comprises a contact portion 109a, a press-fit fixing portion 109b, a tine portion 109c, and lugs 109d. In the contact member 109, by stamping out and bending a thin metal plate with a high electric conductivity such as a copper alloy, for example, the contact portion 109a, the press-fit fixing portion 109b, the tine portion 109c and the lugs 109d are integrally formed. The contact member 109 is made of a thin metal plate, and therefore, each of the components has resiliency.

The contact portion 109a is the region for contact with the contact member 9 of the mating connector. Here, a free end side of the contact portion 109a will be called a front end, and a side connecting to the tine portion 109c will be called a rear end. The contact portion 109a is connected at the rear end to the press-fit fixing portion 109b, which is press-fitted into a bottom floor 116 of the housing 104. The contact portion 109a is received by the contact receiving groove 144b of the housing 104.

The tine portion 109c is electrically connected to a wiring board (not shown) mounted with the receptacle connector 100. The tine portion 109c has its one end connected to the press-fit fixing portion 109b. Further, the tine portion 109c forms an angle of about 900 with respect to the contact portion 109a.

The above contact portion 109a, press-fit fixing portion 109b and the tine portion 109c are similar to the respective portions of a known contact.

The lugs 109d are provided at both side surfaces, opposed to the width direction of the press-fit fixing portion 109b. The lug 109d comprises a support piece 109d1, extending from a side surface of the contact portion 109a, and an inclined piece 109d2, which is connected to the support piece 109d1 extending toward the rear end. The support piece 109d1 is provided on the same plane as the contact portion 109a. The inclined piece 109d2 is provided to form a predetermined angle e with respect to the support piece 109d1, and with respect to the contact portion 109a. The inclined piece 109d2 has elasticity, and functions as a spring. The contact portion 109a is integrally constructed with the lugs 109d. Further, the inclined pieces 109d2 are disposed at the opposite side from the contact portion 109a with respect to the press-fit fixing portion 109b.

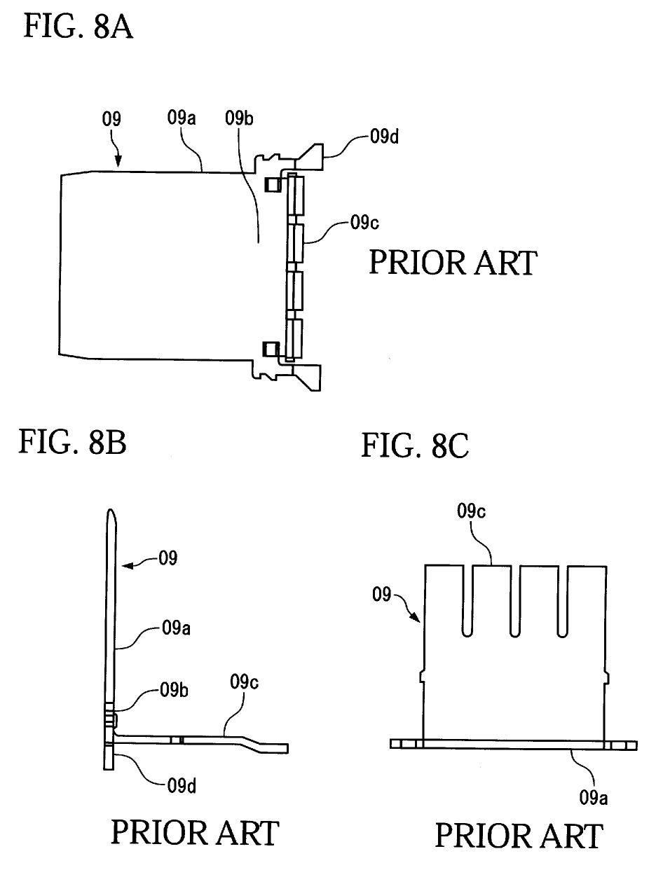

FIGS. 8A to 8e are views showing a conventional contact member 09 known to the art, FIG. 8A shows a front view, FIG. 8B shows a side view and FIG. 8e shows a plan view.

The components corresponding to the contact portion 109a, the tine portion 109c and the lug 109d of the contact member 109 of the present invention, are assigned with reference numerals and characters 09a, 09b and 09c, respectively.

The conventional contact member 09 differs from the contact member 109 of the present invention, in that the entire lug 09d is provided on the same plane as the contact portion 09a. The contact member 109 is inserted into the housing 104 in the direction of the solid line arrow.

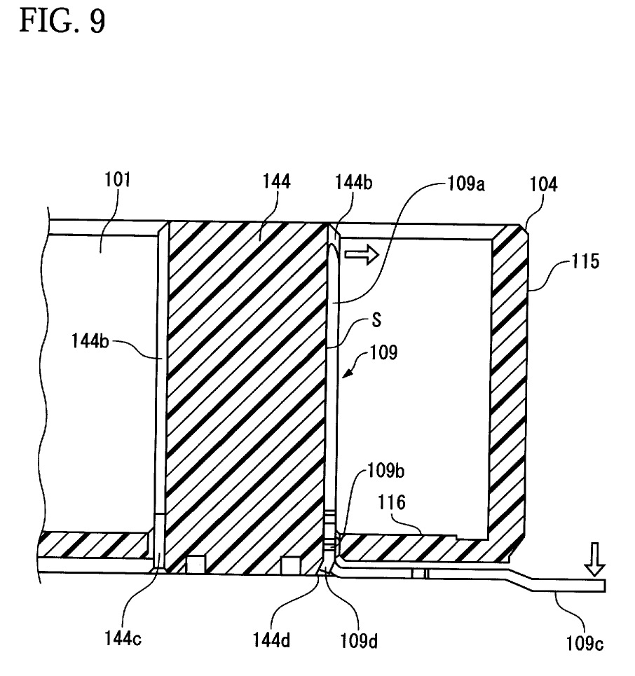

FIG. 9 is a partial sectional view showing the state in which the contact member 109, of the present invention, is held in the housing 104 of the receptacle connector 100. The contact member 109 is press-fitted into the housing 104 from below in FIG. 9.

The contact portion 109a of the contact member 109 is received in the contact receiving groove 144a, which is formed in the mating rib 144. Further, the press-fit fixing portion 109b of the contact member 109 is press-fitted into a press-fit hole 144c, which is formed in the bottom floor 116 of the housing 104. The contact member 109 is restrained by the housing 104 by only the press-fit fixing portion 109b.

The lugs 109d are located at both ends in the width direction of the press-fit hole 144c. Meanwhile, pressing surfaces 144d formed on the same plane as the support surface S are formed at the positions corresponding to the lugs 109d.

A force is assumed to be applied to the tine portion 109c of the contact member 109 in the direction of the outlined arrow. The contact member 109 is restrained by the housing 104 by only the press-fit fixing portion 109b, and therefore, the contact member 109 is to rotate in the direction shown by the outlined arrow with the press-fit fixing portion 109b as a center. However, the inclined pieces 109d2 of the lugs 109d are projected to the support surface S side from the contact portion 109a, and therefore, are pressed by the pressing surfaces 144d in the press-fit hole 144c. Since the contact portion 109a is formed integrally with the inclined pieces 109d2 via the press-fit fixing portion 109b, a force pressing to the support surface S is applied to the contact portion 109a as shown by the outlined arrow. This force prevents the contact portion 109a from being lifted from the support surface S.

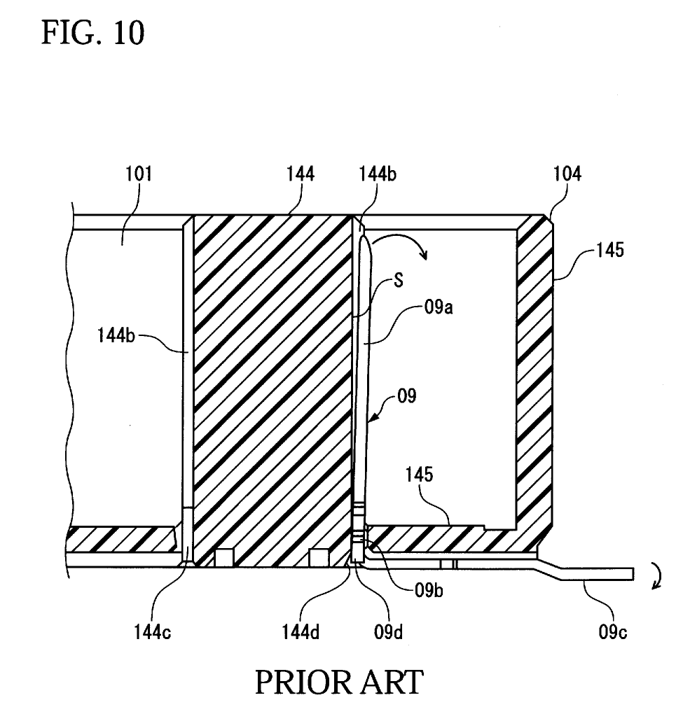

FIG. 10 is a view in which the contact member 109 of FIG. 9 is replaced with the conventional contact member 09.

In reference to the conventional contact member 09, the lugs 09d are disposed parallel along the support surface S. Accordingly, when a force is applied to the tine portion 09c in the arrow direction, the contact portion 09a rotates, in the arrow direction, with the press-fit fixing portion 09b as the center of rotation. As a result, the contact portion 09a is lifted from the support surface S.

In contradistinction, and according to the present embodiment, even if a force is applied to the tine portion 109c of the contact member 109 in the direction of the arrow shown in FIG. 9, the inclined pieces 109d2 are pressed by the pressing surfaces 144d, whereby a force that presses the contact portion 109a against the support surface S occurs. Therefore, the contact portion 109a is not lifted from the support surface S.

As described above, the contact member 109 can prevent the contact portion 109a from being lifted from the support surface S, whereby the contact member 109 is held in the housing 104 by the lugs 109d. The lugs 109d generate a resulting force that presses the contact portion 109a to the support surface S of the mating rib 144, such that the mating rib 144 becomes substantially integral with the contact portion 109a. The effect of the resulting force can be obtained without making the bottom floor 116 of the housing 104 thick.

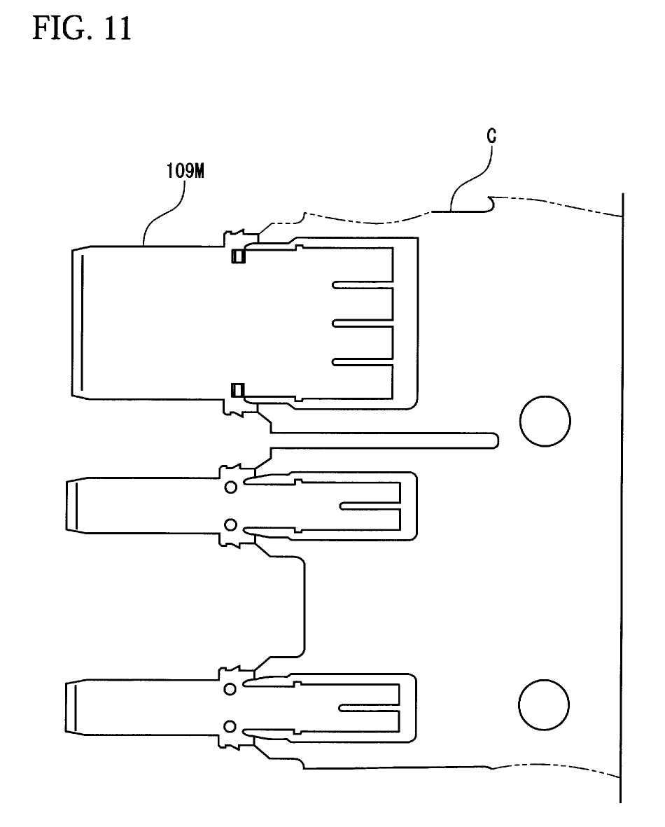

Further, the present embodiment has the advantage of being capable of preventing the contact portion 109a from being lifted from the support surface S by only forming the inclined pieces 109d2 at part of the lugs 109d, without adding a new member. Hereinafter, this point will be described with reference to FIG. 11.

FIG. 11 is a view showing the state of the contact member 109 in the manufacturing process, and shows the state in which an intermediate body 109M of the contact member 109 is formed by stamping out a thin metal plate. FIG. 11 also shows the example in which the intermediate bodies of another kind of contact member are simultaneously formed.

In the intermediate body 109M, the portions corresponding to the lugs 109d of the contact member 109 are connected to a carrier C via a notch portion, and the contact member 109 is finally cut off from the carrier C by being cut at a predetermined position. The notch portion, is a portion that is formed to have a narrow width, capable of being easily cut off or broken off from the carrier C. Bending of the tine portion 109c, and the inclined pieces 109d2, is performed either before or after cutting the carrier C, and the inclined pieces 109d2 can be bent simultaneously with the tine portion 109c.

By simultaneously forming the intermediate body 109M of the contact member 109 and the intermediate bodies of another kind of contact member, in such a way that they are connected to the carrier C, the intermediate bodies of either kind of contact member can be handled together. Therefore, the various contact members can be stamped out together, and further preparation of the contact members, such as bending, can be applied, whereby high and efficient productivity can be attained. The lugs 109d are formed from the notch portion connecting the carrier C, as well as the intermediate body 109M of the contact member 109, when the manufacturing method described above is adopted. Therefore, according to the present embodiment, the advantages associated with the lugs 109d, which prevent the contact portion 109a from being lifted from the support surface S, are provided without an increase in cost.

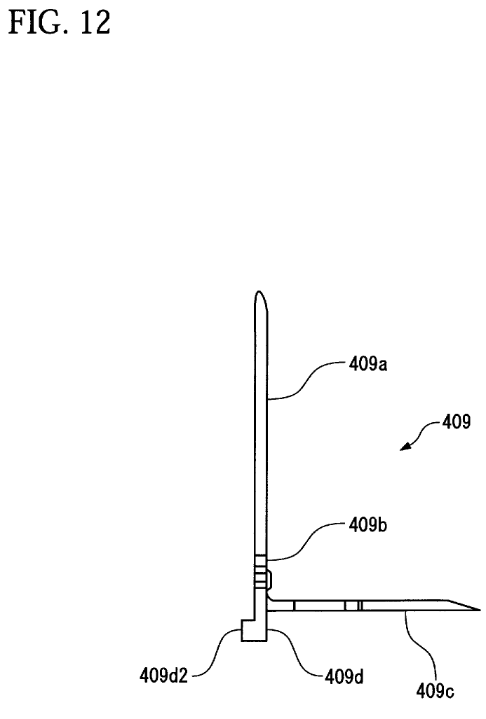

In the above, the inclined pieces 109d2 are provided in the lugs 109d, but other constitutions can be adopted as long as they exhibit similar functions. For example, instead of the inclined piece 109d2, a projection can be provided. FIG. 12 shows an example of it. A contact member 409 includes a press-fit fixing portion 409b and a tine portion 409c, and a lug 409d is formed on the same plane as the contact portion 409a, but a projection 409d2 projected to the support surface S side of the mating rib 144 is formed at a tip end of the lug 409d.

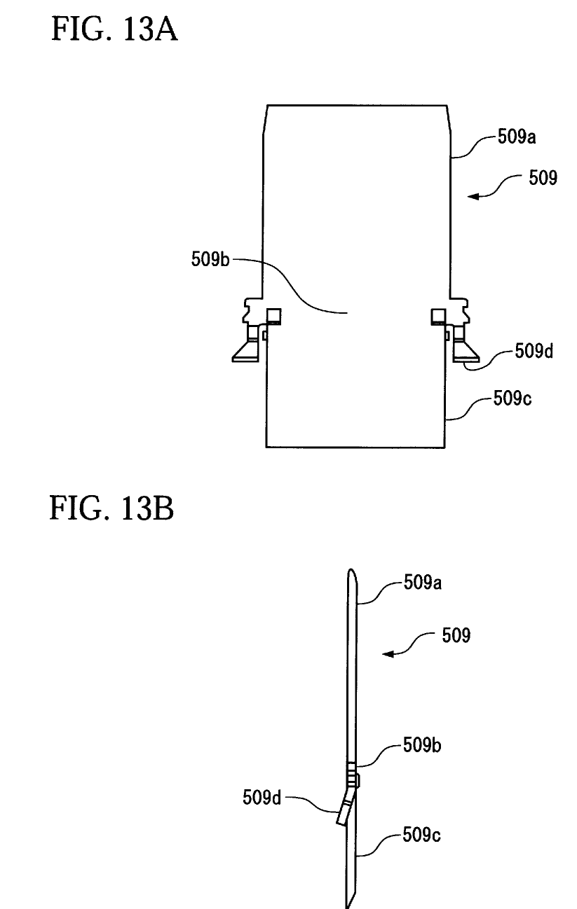

The L-shaped contact member 109 is not limited to the particular embodiment described above. For example, as shown in FIG. 13, the present invention may feature another embodiment of a contact member 509 comprising a contact portion 509a, a press-fit fixing portion 509b, a tine portion 509c and lugs 509d, and as a whole is formed in a flat I-shape. In the contact member 509, the lug 509d has a similar constitution and function as the lug 109d, described above. The L-shaped contact member 109 may be used with a surface mounting connector, whereas the 1shaped contact member 509 may be used with a connector that is mounted to a circuit board, with a through-hole being formed.

Further, as shown in FIGS. 7A and 7B, the inclined pieces 109d2 are formed on both sides of the contact member 109. It is possible, according to the invention, to form the inclined piece 109d2 only on one side of the contact member 109. However, when the width of the contact portion 109a is wide, it becomes difficult to exert the force necessary to press the contact portion 109a against the mating rib 144 on the entire area, in the width direction, of the contact portion 109a, if the inclined piece 109d2 is only formed on one side of the contact member 109. Accordingly, one embodiment, of the present invention, having the inclined piece 109d2, only on one side of the contact member 109, may be best applied in the case where the width of the contact portion 109a is relatively narrow.

In addition to the above, it is possible to adopt, omit and select the constitutions cited in the above described embodiment, or properly change the constitutions to other constitutions as long as they do not depart from the gist of the present invention, that is, the gist that the lug generates the necessary force to presses flat the contact portion to the support surface, so that support surface integrally forms with the contact portion.

The lug 109d in the contact member 109 of the present invention may formed as any shape, as long as the lug 109d includes a support piece 109d1 that is connected to the press-fit fixing portion 109b, and is provided on the same plane as the contact portion 109a and an inclined piece 109d2 that is extended from the support piece 109d1 in a direction in which the mating contact member 109 is inserted, with a tip end of it being inclined to be close to the support surface S. The lug 109d of the contact member 109 can be formed without adding a new process step, in the process of manufacturing the contact member 109.

Further, the lugs 109d are preferably provided at both side surfaces in a width direction of the press-fit fixing portion 109b. This is because the contact portion 109a can be more reliably pressed to the support surface S.

The present invention provides a holding structure of a contact member 109 using the above contact member 109. More specifically, the present invention provides a holding structure of a contact member 109 with respect to a housing 104, in which a press-fit fixing portion 109b is press-fitted into a press-fit hole 144c formed in the housing 104, and a contact portion 109a is disposed along a support surface S formed in the housing 104, and is characterized in that the contact member 109 includes the flat contact portion 109a that is in contact with a mating contact member 109, and is disposed along the support surface S, a flat press-fit fixing portion 109b that is connected to the contact portion 109a and press-fitted into the press-fit hole 144c, a tine portion 109c connected to the press-fit fixing portion 109b, and a lug 109d extending from a side surface of the press-fit fixing portion 109b, the lug 109d includes a inclined piece 109d2 projected to the support surface S side from the contact portion 109a, and the inclined piece 109d2 is disposed at a side opposite from the contact portion 109a with respect to the press-fit fixing portion. The housing 104 is characterized by including a pressing surface 144d, which presses the inclined piece 109d2 of the lug 109d.

In the above holding structure of the contact member 109, the lug 109d preferably includes a support piece 109d1, which is connected to the press-fit fixing portion 109b and is provided on the same plane as the contact portion 109a, and an inclined piece 109d2 that is extended from the support piece 109d1 in a direction in which the mating contact member 109 is inserted, with a tip end of it being inclined to be close to the support surface S. In the holding structure, the tip end of the inclined piece 109d2 is pressed by the pressing surface S.

Further, in the above holding structure of the contact member 109, the lugs 109d are preferably formed on both side surfaces, in a width direction of the press-fit fixing portion 109b, and in this case, the pressing surfaces are provided at both sides in a width direction of the press-fit hole 144c.

The present invention provides an electrical connector using the above contact member 109. The electrical connector comprises a first connector, such as a plug connector 10, mounted on a first printed wiring board, and a second connector, such as receptacle connector 100, mating with the first connector and mounted on a second printed wiring board. Anyone of the first connector and the second connector includes a housing including a press-fit hole 144c and a support surface S, and a plurality of contact members 108, 109 held in the housing, at least one of the contact members includes a flat contact portion 109a that is in contact with a mating contact member 108, and is disposed along the support surface S, a flat press-fit fixing portion 109b that is connected to the contact portion 109a and press-fitted into the press-fit hole 144c, a tine portion 109c connected to the press-fit fixing portion 109b, and a lug 109d extending from a side surface of the press-fit fixing portion 109b, the lug 109d includes a inclined piece 109d2 projected to the support surface S side from the contact portion 109a, and the inclined piece 109d2 is disposed at a side opposite from the contact portion 109a with respect to the press-fit fixing portion 109b. The housing is characterized by including a pressing surface, which presses the inclined piece 109d2 of the lug.

In the above connector, the lug 109d also preferably includes a support piece 109d1 that is connected to the press-fit fixing portion 109b and is provided on the same plane as the contact portion, and an inclined piece 109d2 which is extended from the support piece 109d1 in a direction in which the mating contact member 108 is inserted, with a tip end of it being inclined to be close to the support surface S, and the tip end of the inclined piece 109d2 is pressed by the pressing surface. Further, in the above connector, the lugs 109d are preferably provided at both side surfaces in a width direction of the press-fit fixing portion 109b, and in this case, the pressing surfaces are provided at both sides in a width direction of the press-fit hole 144c.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A contact member of an electrical connector, comprising:
a flat contact portion for contact with said mating contact member, and disposed along a support surface of a housing;
a flat press-fit fixing portion which is connected to a contact portion and is press-fitted into a press-fit hole of the housing;
a tine portion connected to said press-fit fixing portion; and
a lug extending from a side surface of said press-fit fixing portion,
wherein said lug includes an inclined piece projected to said support surface from said contact portion, and said inclined piece is disposed at a side opposite from said contact portion.

2. The contact member according to claim 1, wherein said lug includes
a support piece which is connected to said press-fit fixing portion and is provided on the same plane as said contact portion, and
an inclined piece which is extended from said support piece in a direction in which said mating contact member is inserted, with a tip end of it being inclined to be close to said support surface.

3. The contact member according to claim 1, wherein said lugs are provided at both side surfaces in a width direction of said press-fit fixing portion.

4. The contact member according to claim 2, wherein said lugs are provided at both side surfaces in a width direction of said press-fit fixing portion.

5. A holding structure of a contact member in which a press-fit fixing portion is press-fitted into a press-fit hole formed in a housing, and a contact portion is disposed along a support surface formed in said housing, wherein said contact member comprises:
a flat contact portion for contact with a mating contact member, being disposed along said support surface,
a flat press-fit fixing portion which is connected to said contact portion, and is press-fitted into said press-fit hole,
a tine portion connected to said press-fit fixing portion; and
a lug extending from a side surface of said press-fit fixing portion, wherein said lug includes an inclined piece projected to said support surface side from said contact portion, said inclined piece is disposed at a side opposite from said contact portion and said housing includes a pressing surface which presses said inclined piece of said lug.

6. The holding structure of a contact member according to claim 5, wherein said lug comprises:
a support piece which is connected to said press-fit fixing portion, and is provided on the same plane as said contact portion, and
an inclined piece which is extended from said support piece in a direction in which said mating contact member is inserted, with a tip end of it being inclined to be close to said support surface, and
a tip end of said inclined piece is pressed by said pressing surface.

7. The holding structure of a contact member according to claim 5, wherein said lugs are provided at both side surfaces in a width direction of said press-fit fixing portion, and
said pressing surfaces are provided at both sides in a width direction of said press-fit hole.

8. The holding structure of a contact member according to claim 6, wherein said lugs are provided at both side surfaces in a width direction of said press-fit fixing portion, and
said pressing surfaces are provided at both sides in a width direction of said press-fit hole.

9. An electrical connector comprising:
a first connector mounted on a first printed wiring board, and
a second connector which mates with said first connector and mounted on a second printed wiring board, wherein anyone of said first connector and said second connector includes
a housing including a press-fit hole and a support surface and
a plurality of contact members held in said housing, at least one of said contact members comprises:
a flat contact portion which is in contact with a mating contact member, and is disposed along said support surface,
a flat press-fit fixing portion which is connected to said contact portion, and is press-fitted into said press-fit hole,
a tine portion connected to said press-fit fixing portion; and
a lug extending from a side surface of said press-fit fixing portion, said lug comprises an inclined piece projected to said support surface side from said contact portion, said inclined piece is disposed at a side opposite from said contact portion with respect to said press-fit fixing portion, and
said housing includes a pressing surface which presses said inclined piece of said lug.

10. The electrical connector according to claim 9, wherein said lug comprises
a support piece which is connected to said press-fit fixing portion, and is provided on the same plane as said contact portion, and
an inclined piece which is extended from said support piece in a direction in which said mating contact member is inserted, with a tip end of it being inclined to be close to said support surface, and the tip end of said inclined piece is pressed by said pressing surface.

11. The electrical connector according to claim 9, wherein said lugs are provided at both side surfaces in a width direction of said press-fit fixing portion, and said pressing surfaces are provided at both sides in a width direction of said press-fit hole.

12. The electrical connector according to claim 10, wherein said lugs are provided at both side surfaces in a width direction of said press-fit fixing portion, and said pressing surfaces are provided at both sides in a width direction of said press-fit hole.
